(19) United States
(12) Patent Application Publication
(10) Pub. No.: US 2026/0133886 A1
(43) Pub. Date: May 14, 2026

(54) Compute Resource Overcommitment Through Statistical Usage Prediction

(71) Applicant: Google LLC, Mountain View, CA (US)

(72) Inventors: Weihao Kong, Bothell, WA (US); Zhiyuan Liu, Santa Clara, CA (US); Peiyuan Liu, Santa Clara, CA (US); Nan Deng, Mountain View, CA (US); Yihua Ding, Santa Clara, CA (US); Sunan Xiang, Sunnyvale, CA (US); Lakshmi Kasinathan, Sunnyvale, CA (US); Sahil Shekhawat, San Jose, CA (US); Shiyu Hu, Mason, OH (US); Patrick Hin Fun Hung, San Bruno, CA (US); Sreekumar Vadakke Kodakara, Campbell, CA (US); Ashish Vibhakar Naik, Los Altos, CA (US); Adhimanyu Das, San Jose, CA (US); Zhijing Qin, Mountain View, CA (US); Gaurav Dhiman, Sunnyvale, CA (US); Ziliang Zhu, Santa Clara, CA (US)

(21) Appl. No.: 18/941,122

(22) Filed: Nov. 8, 2024

(51) Int. Cl. G06F 11/34

(52) U.S. Cl. CPC G06F 11/3452

(57) ABSTRACT

Aspects of the disclosure are directed to predicting compute resource usage over time for various tasks in a multi-tenant compute cluster to allow for overcommitting the tasks on physical machines of the multi-tenant compute cluster. Overcommitting the tasks can result in hardware savings, as fewer physical machines are needed to run additional workloads. A machine learning model can predict the compute resource usage over time by predicting resource usage per task based on statistics of intervals of monitored task resource usages and combining the predicted task resource usages to generate a total predicted resource usage for a physical machine.

### BACKGROUND

In a multi-tenant compute cluster, a physical machine can run workloads from different users. Each workload can specify an amount of compute resources needed to run the workload. However, due to fluctuating compute demand, these workloads rarely use all of this amount all of the time. For example, users perform search and watch more videos during the day than at night, so the amount of compute resources for these workloads are higher during the day and lower at night. When two or more workloads run on the same physical machine, workloads can be selected such that their resource usage patterns complement one another, e.g., usage of one workload is higher while usage of the other workload is lower. Such a combination of workloads can allow for resource overcommitment, where a physical machine can run multiple workloads requiring more total resources than the physical capacity of that machine. However, resource usage patterns for workloads are typically unknown until they are run, but workloads being run are already scheduled to a physical machine. Therefore, rather than knowing the resource usage patterns, these patterns can be predicted to allow for resource overcommitment. Predicting these patterns can be difficult though, due to high frequency sampling and the large data amounts involved in the prediction, particularly when the data is time-series data.

### BRIEF SUMMARY

Aspects of the disclosure are directed to predicting compute resource usage over time for various tasks in a multi-tenant compute cluster to allow for overcommitting the tasks on physical machines of the multi-tenant compute cluster. Overcommitting the tasks can result in hardware savings, as fewer physical machines are needed to run additional workloads. A machine learning model can predict the compute resource usage over time by predicting resource usage per task based on statistics of intervals of monitored task resource usages and combining the predicted task resource usages to generate a total predicted resource usage for a physical machine.

An aspect of the disclosure provides for a method for overcommitting compute resources on a physical machine of a multi-tenant compute cluster, the method including: monitoring, by one or more processors, resource usage for one or more tasks running on the physical machine; predicting, by the one or more processors, a future resource usage for the one or more tasks using a machine learning model based on statistics associated with intervals of the monitored resource usage; receiving, by one or more processors, a resource request associated with an additional task; determining, by the one or more processors, that the additional task can run on the physical machine based on the future resource usage; and running, by the one or more processors, the additional task on the physical machine.

Another aspect of the disclosure provides for a system including: one or more processors; and one or more storage devices coupled to the one or more processors and storing instructions that, when executed by the one or more processors, cause the one or more processors to perform operations for the method for overcommitting compute resources on a physical machine of a multi-tenant compute cluster. Yet another aspect of the disclosure provides for a non-transitory computer readable medium for storing instructions that, when executed by one or more processors, cause the one or more processors to perform operations for the method for overcommitting compute resources on a physical machine of a multi-tenant compute cluster. Yet another aspect of the disclosure provides for a computer program including instructions that, when executed by one or more processors, cause the one or more processors to perform operations for the method for overcommitting compute resources on a physical machine of a multi-tenant compute cluster.

In some examples, a task of the one or more tasks specifies an amount of compute resources for running that task. In some examples, compute resources include at least one of number of processor cores, amount of memory, network bandwidth, or storage capacity. In some examples, the future resource usage is predicted as time series data. In some examples, the intervals include at least one of a time or confidence interval. In some examples, the machine learning model includes at least one of a dense encoder or a Gaussian mixture model.

In some examples, predicting the future resource usage further includes: generating, for each task, the statistics associated with intervals of the monitored resource usage; predicting, for each task, a per task future resource usage using the respective statistics; and combining the per task future resource usages based on the statistics. In some examples, the per task future resource usages are combined using a Bernstein inequality. In some examples, determining that the additional task can run on the physical machine based on the future resource usage further includes determining that the future resource usage added to a resource usage of the resource request is less than or equal to a resource capacity of the physical machine.

In some examples, the method further includes storing, by the one or more processors, the monitored resource usage as a historical resource usage for the one or more tasks. In some examples, the method further includes training, by the one or more processors, the machine learning model using the historical resource usage for determining the future resource usage for the physical machine.

### BRIEF DESCRIPTION OF THE DRAWINGS

FIG. 1 depicts a block diagram of an example multi-tenant compute cluster according to aspects of the disclosure.

FIG. 2 depicts a block diagram of an example predictor according to aspects of the disclosure.

FIG. 3 depicts a block diagram of an example scheduler according to aspects of the disclosure.

FIG. 4 depicts a block diagram of an example simulator according to aspects of the disclosure.

FIG. 5 depicts a block diagram of an example environment for implementing a multi-tenant compute cluster according to aspects of the disclosure.

FIG. 6 depicts a flow diagram of an example process for overcommitting compute resources on a physical machine of a multi-tenant compute cluster according to aspects of the disclosure.

### DETAILED DESCRIPTION

The technology relates generally to using a machine learning model to predict compute resource usage for overcommitting the compute resources per physical machine in a multi-tenant compute cluster. The cluster includes a plurality of physical machines that respectively run tasks or workloads. The tasks can specify an amount of compute resources needed to run the task. For example, the tasks can specify a compute resource amount as a maximum value per resource type. Resource types can include the number of processor cores, the amount of memory, the network bandwidth, and/or the storage capacity, as examples. The machine learning model can predict future usage of tasks over time to allow the cluster to schedule complementary tasks on the physical machines such that the total amount of resources requested from tasks per machine can be higher than the compute resource capacity of that machine.

The multi-tenant compute cluster can include one or more predictors, an online scheduler, and an offline simulator. The one or more predictors can each be associated with a respective physical machine. For each physical machine, the associated predictor can monitor resource usage for the tasks running on that physical machine, store the monitored resource usage as historical resource usage, and predict a future resource usage based on the monitored resource usage and metadata for the tasks. The future resource usage and historical resource usage can be represented as time series data or elements in a tensor, as examples. The predictors can send the future resource usage of each physical machine to the online scheduler and the historical resource usage of each physical machine to the offline simulator. The predictors can predict future resource usage periodically, based on one or more events, e.g. a new task arrival or an old task departure, or in response to a query, as examples. Periodic predictions can be a tunable interval, such as to perform a prediction every 5 minutes.

The predictors can include a machine learning model trained to determine the future resource usage for a physical machine, e.g., an amount of resource usage over time based on a given set of tasks run together on that physical machine. The machine learning model can include a neural network, such as a dense encoder, and a statistical model, such as a Gaussian mixture model. The machine learning model may alternatively include two statistical models. The machine learning model can predict the future resource usage per task based on metadata and monitored resource usage of each task. Example metadata can include usernames, owners, geolocation, and/or resource requests. The machine learning model can represent the future resource usage as a statistical distribution, time series data, or values in a tensor. For example, the monitored resource usage can be represented as a time series of statistics and the metadata can be represented as a numerical vector embedding.

The numerical vector embedding can be concatenated with the time series of statistics to form the input for the machine learning model. The machine learning model can generate statistics for intervals, e.g., time or confidence intervals, of the future resource usage. A confidence interval can refer to a range where the predicted value is likely to be and may include a probability along with the range. For example, confidence intervals may be a 50% chance predicted usage at a given time is within range [10, 20] or an 80% chance predicted usage at a given time is within range [5, 21]. The statistics can include mean, standard deviation, and/or maximum deviation of each interval, as examples. The machine learning model can combine the future resource usage per task into a combined future resource usage for the physical machine based on the statistics. For example, the machine learning model or a downstream operation from the output of the machine learning model can use a Bernstein inequality to combine the future resource usages weighted by the statistics into the combined future resource usage. Alternatively, or additionally, the machine learning model can use a Monte-Carlo calculation by iteratively drawing random numbers from the future resource usages and summing the random numbers.

The scheduler can receive a resource request associated with a task and find a physical machine to run the task based on the resource request and the future resource usages of the physical machines in the cluster. For example, the scheduler can find a physical machine where the future resource usage of that machine combined with the resource request is less than or equal to the resource capacity of that machine. Alternatively, or additionally, the scheduler can receive a task, predict a future resource usage for the task, and find a physical machine to run the task based on both the future resource usage of the task and the future resource usage of the tasks already running on the physical machines. Once the task starts running on a physical machine, the predictor for that machine monitors the resource usage and incorporates that resource usage into predicting the future resource usage.

The offline simulator can use the historical resource usage to train the predictors and/or monitor the performance, e.g., accuracy, of the predictors. The offline simulator can generate training data from the historical resource usage and use the training data to train the machine learning models of the predictors. The offline simulator can also evaluate the predictors by comparing their future resource usage prediction to a ground truth. The ground truth can be generated from the historical resource usage as well.

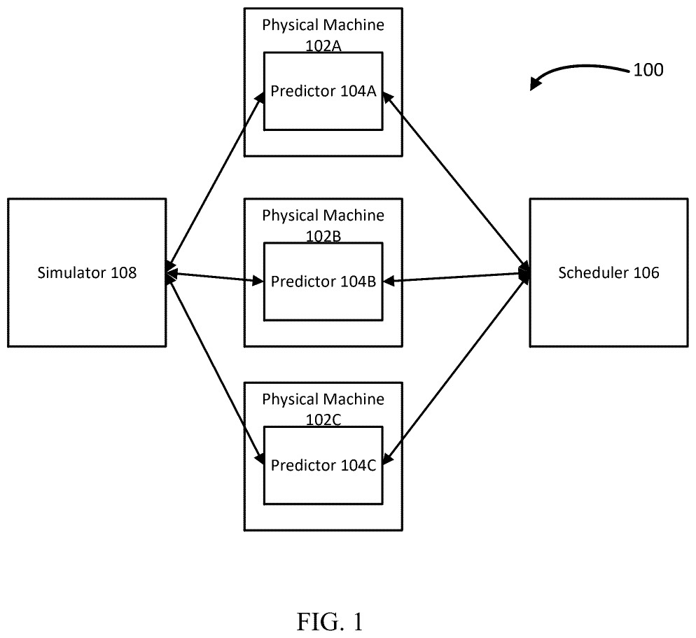

FIG. 1 depicts a block diagram of an example multi-tenant compute cluster 100. The multi-tenant compute cluster 100 can be implemented on one or more computing devices in one or more locations. The multi-tenant compute cluster 100 includes a plurality of physical machines 102 that respectively run workloads or tasks for multiple users. The workloads or tasks can be any of a variety of services or applications, including video streaming, map generation, digital content management, and/or word processing, as examples. It should be noted the terms “task” and “workload” may be used interchangeably throughout the disclosure. Further, while three physical machines 102A-C are depicted in FIG. 1, the multi-tenant compute cluster 100 may include any number of physical machines 102.

The multi-tenant compute cluster 100 further includes an online scheduler 106. The online scheduler 106 can be configured to receive resource requests associated with respective tasks and select which physical machines to run the tasks. For example, the online scheduler 106 can select a physical machine where the received resource usage added to a predicted resource usage is less than or equal to a resource capacity of that physical machine. The online scheduler 106 can send the task to a selected physical machine to run the task.

The multi-tenant compute cluster 100 also includes an offline simulator 108. The offline simulator 108 can be configured to receive historical resource usage of the physical machines 102 for training and/or evaluating machine learning models to predict future resource usage of the physical machines. The offline simulator 108 can output updates to the physical machines 102 based on the training and/or evaluation. Updates can include adjustments to parameters of the machine learning model. While a single online scheduler 106 and offline simulator 108 are depicted in FIG. 1, the multi-tenant compute cluster 100 may include multiple schedulers 106 or simulators 108 each associated with a subset of the plurality of physical machines 102.

The plurality of physical machines 102 may each include a predictor 104 configured to use one or more machine learning models to predict future resource usage for that physical machine. While three predictors 104A-C are depicted in FIG. 1, the multi-tenant compute cluster 100 may include any number of predictors 104. Alternatively, or additionally, a predictor may be associated with multiple physical machines such that the predictor is configured to use the machine learning model to predict future resource usage for those multiple physical machines. For example, the scheduler 106 may include its own predictor configured to predict future resource usage for a subset of the plurality of physical machines 102.

Each predictor 104 can, for its respective physical machine 102, monitor resource usage per task, generate statistics for intervals of the monitored resource usage per task, predict future resource usage per task using the statistics, and combine the future resource usages weighted by the statistics into a total future resource usage for that physical machine. Alternatively, or additionally, the predictors 104 can receive the monitored resource usage per task. The predictors 104 can be configured to output the total future resource usages for each physical machine 102 to the scheduler 106 for scheduling additional tasks on physical machines 102 that complement the current tasks running on those physical machines 102 to allow for resource overcommitment. The predictors 104 can also be configured to store the future resource usage as historical resource usage and output the historical resource usage to the offline simulator 108 for training and/or evaluation of the machine learning models.

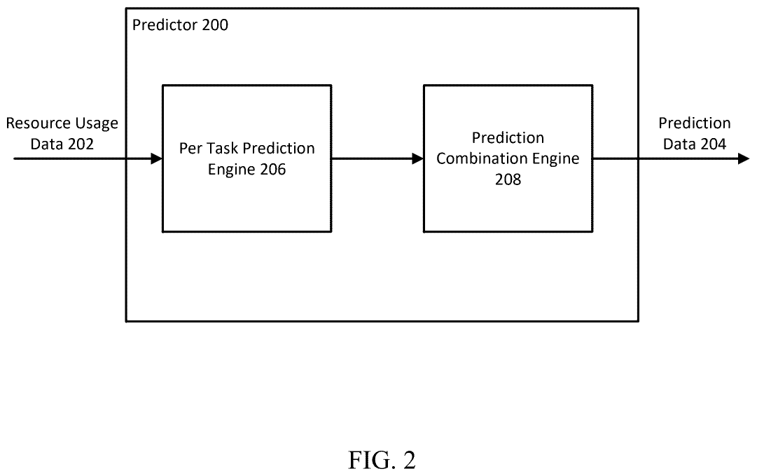

FIG. 2 depicts a block diagram of an example predictor 200 for predicting future resource usage using a machine learning model. The predictor 200 can be implemented on one or more computing devices in one or more locations. For example, the predictor 200 can be implemented on a physical machine or a scheduler of a multi-tenant compute cluster, such as one of the physical machines 102 or scheduler 106 of the multi-tenant compute cluster 100 as depicted in FIG. 1.

The predictor 200 can be configured to receive resource usage data 202. Resource usage data 202 can include a current amount of compute resources being used to run one or more tasks on the physical machines associated with the predictor 200. The current amount of compute resources can be determined through monitoring, either by the predictor 200 itself or the physical machines. The amount of compute resources can specify a compute resource amount as a maximum value per resource type. As examples, resource types may include number of processor cores, amount of memory, memory or network bandwidth, and/or storage capacity. The resource usage data 202 may also include metadata for identifying the current amount of compute resources with particular tasks or users. Example metadata can include usernames, owners of tasks, geolocation of tasks, and/or compute resource requests.

The predictor 200 can receive the resource usage data 202 as part of a call to an application programming interface (API) exposing the predictor 200 to one or more computing devices. The predictor 200 may also receive the resource usage data 202 through a storage medium, such as remote storage connected to one or more computing devices over a network, and/or through a user interface on a client computing device.

Based on the resource usage data 202, the predictor 200 can be configured to output prediction data 204. Prediction data 204 can include future resource usage, such as a future amount of compute resources that may be required to run the one or more tasks on the physical machines associated with the predictor 200.

The predictor 200 can be configured to send the prediction data 204 to the scheduler and/or simulator of the multi-tenant compute cluster. The predictor 200 can be configured to send the prediction data 204 as a set of computer-readable instructions, such as one or more computer programs. The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model. The predictor 200 can further be configured to forward the prediction data 204 to one or more other devices configured for translating the prediction data 204 for display or into an executable program written in a computer programming language. The predictor 200 can also be configured to send the prediction data 204 to a storage device for storage and later retrieval and/or send the prediction data 204 for display on a client device.

The predictor 200 can include a per task prediction engine 206 and a prediction combination engine 208. The per task prediction engine 206 and prediction combination engine 208 may be implemented as one or more computer programs, specially configured electronic circuitry, or any combination thereof.

The per task prediction engine 206 can be configured to determine per task future resource usages using a machine learning model. The per task future resource usage can be statistics for a predicted amount of resource usage over time for a particular task. The machine learning model can include a neural network, such as a dense encoder, or a statistical model, such as a Gaussian mixture model, for determining the per tasks future resource usages. The machine learning model can determine the per task future resource usages based on the resource usage data 202. For example, the per task prediction engine 206 can represent the monitored amount of compute resources as a time series of statistics and the metadata as a numerical vector embedding. The time series of statistics concatenated with the numerical vector embedding can be input to the machine learning model and the machine learning model can output the per task future resource usage as a statistical distribution, time series data, and/or values in a tensor. Processing statistics of the monitored resource usage data by the machine learning model as opposed to processing the resource usage data itself reduces the amount of data to process, thus saving processing costs and memory usage as well as improving the speed at which the machine learning model can output per task future resource usages.

The per task prediction engine 206 can generate the statistics for intervals of the monitored resource usages per task. The intervals can be time intervals or confidence intervals, as examples. Time intervals refer to ranges of time over the per task future resource usages and confidence intervals refer to ranges of a predicted value at a given time. The confidence intervals may include a probability along with the value range to indicate a level of confidence in the predicted value. Example statistics can include mean, standard deviation, and/or maximum deviation of the intervals, as examples.

The prediction combination engine 208 can be configured to combine the per task future resource usages into a total future resource usage for the physical machines associated with the predictor 200. The prediction combination engine 208 can combine the per task future resource usages using a machine learning model. The machine learning model can be a statistical model, such as a Gaussian mixture model. The prediction combination engine 208 can combine the per task future resource usages based on the statistics, such as using the Bernstein inequality to combine and weight the statistics into the total future resource usage. For example, the Bernstein inequality can be represented as

$${μ}_{1} + {μ}_{2} + a * \sqrt{{σ}_{1}^{2} + {σ}_{2}^{2}} + b * max ( {Ψ}_{1} , {Ψ}_{2} ) ,$$

where 1, 2, etc. represent the tasks being combined, u is the mean for that task, σ is the standard deviation for that task, Ψ is the maximum deviation for that task, and a and b are tunable parameters to weight the combination. Alternatively, or additionally, the machine learning model can use a Monte-Carlo calculation to combine and weight the statistics into the total future resource usage. For example, the Monte-Carlo calculation can involve iteratively drawing random numbers for the per task future resource usages and summing the random numbers to generate the total future resource usage.

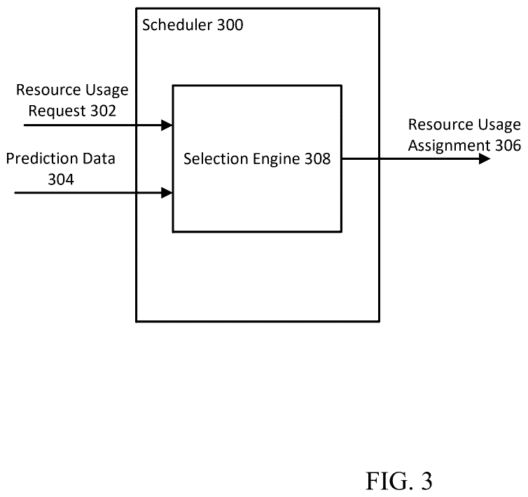

FIG. 3 depicts a block diagram of an example scheduler 300 for scheduling tasks on physical machines based on predicted resource usage from the predictors. The scheduler 300 can be implemented on one or more computing devices in one or more locations. For example, the scheduler 300 can correspond to the scheduler 106 of the multi-tenant compute cluster 100 as depicted in FIG. 1.

The scheduler 300 can be configured to receive resource usage requests 302. The resource usage request 302 can be a request to run a new task on a physical machine of the multi-tenant compute cluster. The resource usage request 302 can identify the task and specify the amount of compute resources needed to run the task. The amount of compute resources can be specified as a peak value per resource type. The scheduler 300 can receive the resource usage requests 302 from user or client devices implementing the new task. The scheduler 300 can further be configured to receive prediction data 304. The prediction data 304 can include future resource usage, such as a predicted amount of compute resources to run one or more tasks on physical machines. The prediction data 304 can correspond to the prediction data 204 as depicted in FIG. 2. The scheduler 300 can receive prediction data 304 from multiple predictors in the multi-tenant compute cluster.

The scheduler 300 can receive the requests 302 and/or prediction data 304 as part of a call to an application programming interface (API) exposing the scheduler 300 to one or more computing devices. The scheduler 300 may also receive the requests 302 and/or prediction data 304 through a storage medium, such as remote storage connected to one or more computing devices over a network, and/or through a user interface on a client computing device.

Based on the resource usage requests 302 and prediction data 304, the scheduler 300 can be configured to output a resource usage assignment 306. The resource usage assignment 306 can assign the resource usage request to a physical machine of the multi-tenant compute cluster. The scheduler 300 can send the resource usage assignment 306 to the physical machine the scheduler 300 selects to run the new task associated with the resource usage request 302. The scheduler 300 can send the resource usage assignment 306 as a set of computer-readable instructions, such as one or more computer programs. The scheduler 300 can further be configured to forward the resource usage assignment 306 to one or more other devices configured for translating the resource usage assignment 306 for display or into an executable program written in a computer programming language. The scheduler 300 can also be configured to send the resource usage assignment 306 to a storage device for storage and later retrieval and/or send the resource usage assignment 306 for display on a client device.

The scheduler 300 can include a selection engine 308, which may be implemented as one or more computer programs, specially configured electronic circuitry, or any combination thereof. The selection engine 308 can be configured to select which physical machine to run the new task associated with a resource usage request 302 based on the prediction data 304. The selection engine 308 can select physical machines such that resource usages per task complement one another to allow for resource overcommitment on the physical machines. For example, the selection engine 308 can search for a physical machine where the resource usage of the new task added to the predicted resource usage is less than or equal to a resource capacity of that physical machine. The resource capacity refers to a threshold amount of resources for running tasks on the physical machine. The selection engine 308 can select such a physical machine and assign the new task to that physical machine. Once that task starts running on the physical machine, the predictor for that physical machine may monitor the new resource usage and incorporate that resource usage into predicting future resource usage. Alternatively, or additionally, the scheduler 300 may include a predictor, such as the predictor as depicted in FIG. 2. The scheduler 300 can receive a new task associated with a resource usage request 302, generate the prediction data 304 using the predictor, and search for and assign a physical machine to run the new task based on the generated prediction data 304.

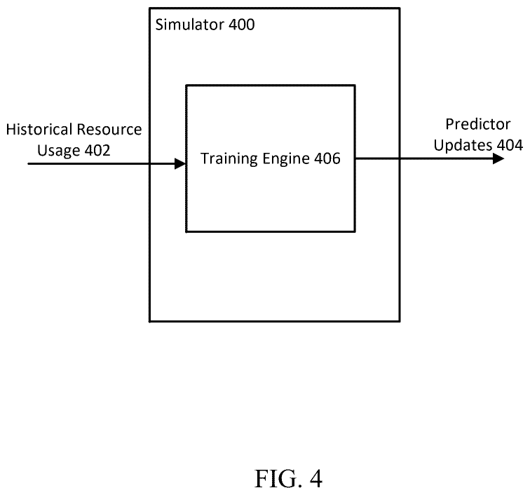

FIG. 4 depicts a block diagram of an example simulator 400 for training and/or evaluating the machine learning models in the predictors. The simulator 400 can be implemented on one or more computing devices in one or more locations. For example, the simulator 400 can correspond to the simulator 108 of the multi-tenant compute cluster 100 as depicted in FIG. 1.

The simulator 400 can be configured to receive historical resource usage 402. The historical resource usage 402 can be previously monitored resource usage for one or more tasks run by a physical machine of the multi-tenant compute cluster. As examples, the historical resource usage 402 can be represented as time series data or elements in a tensor. The simulator 400 can receive the historical resource usage 402 from predictors associated with physical machines of the multi-tenant compute cluster.

The simulator 400 can receive the historical resource usage 402 as part of a call to an application programming interface (API) exposing the simulator 400 to one or more computing devices. The simulator 400 may also receive the historical resource usage 402 through a storage medium, such as remote storage connected to one or more computing devices over a network, and/or through a user interface on a client computing device.

Based on the historical resource usage 402, the simulator 400 can be configured to output performance results and/or updates 404 for the predictors. Performance results can include accuracy results of the predictors with respect to a ground truth and updates for the predictors can include updates to parameters in training the machine learning models of the predictors. The simulator 400 can send the predictor updates 404 to the predictors.

The simulator 400 can be configured to send the predictor updates 404 as a set of computer-readable instructions, such as one or more computer programs. The simulator 400 can further be configured to forward the predictor updates 404 to one or more other devices configured for translating the predictor updates 404 for display or into an executable program written in a computer programming language. The simulator 400 can also be configured to send the predictor updates 404 to a storage device for storage and later retrieval and/or send predictor updates 404 for display on a client device.

The simulator 400 can include a training engine 406, which may be implemented as one or more computer programs, specially configured electronic circuitry, or any combination thereof. The training engine 406 can be configured to train and/or evaluate the machine learning models of the predictors using the historical resource usage 402 to improve the performance of the machine learning models. Improving the performance of the machine learning models can improve the ability of the scheduler to select physical machines for tasks such that the resource usages per task complement one another to allow for resource overcommitment.

The machine learning models can be trained and/or evaluated according to a variety of different learning techniques. Learning techniques for training the machine learning models can include supervised learning, unsupervised learning, semi-supervised learning, and reinforcement learning techniques. For example, training data can include multiple training examples that can be received as input by a model. The training examples can be labeled with a desired output for the model when processing the labeled training examples. The label and the model output can be evaluated through a loss function to determine an error, which can be back propagated through the model to update weights for the model. For example, a supervised learning technique can be applied to calculate an error between outputs, with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be modified or updated until stopping criteria are met, such as a number of iterations for training, a maximum period of time, a convergence of estimated rewards or value between actions, or when a minimum value threshold is met.

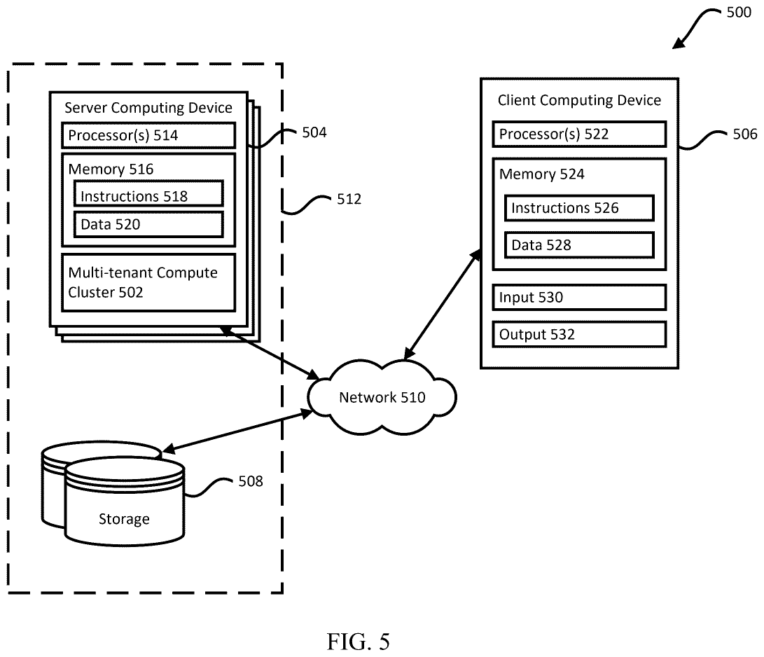

FIG. 5 depicts a block diagram of an example computing environment 500 implementing multi-tenant compute cluster 502. The multi-tenant compute cluster 502 can correspond to the multi-tenant compute cluster 100 as depicted in FIG. 1. The multi-tenant compute cluster 502 can be implemented on one or more devices having one or more processors in one or more locations, such as in a server computing device 504. A client computing device 506 and the server computing device 504 can be communicatively coupled to one or more storage devices 508 over a network 510. The server computing device 504 and the storage devices 508 can form part of a cloud computing system 512 for cloud computing services such as Infrastructure as a Service (IaaS), Platform as a Service (PaaS), and/or Software as a Service (SaaS).

For example, the client computing device 506 may use the cloud computing system 512 as a service that provides software applications, such as accounting, word processing, inventory tracking, fraud detection, file sharing, video sharing, audio sharing, communication, or gaming. As another example, the client computing device 506 can access the cloud computing system 512 as part of one or more operations that employ machine learning, deep learning, and/or artificial intelligence technology to train the software applications. The cloud computing system 512 can provide model parameters that can be used to update machine learning models for the software applications.

The storage devices 508 can be a combination of volatile and non-volatile memory and can be at the same or different physical locations than the computing devices 504, 506. For example, the storage devices 508 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 504 can include one or more processors 514 and memory 516. The memory 516 can store information accessible by the processors 514, including instructions 518 that can be executed by the processors 514. The memory 516 can also include data 520 that can be retrieved, manipulated, or stored by the processors 514. The memory 516 can be a type of non-transitory computer readable medium capable of storing information accessible by the processors 514, such as volatile and non-volatile memory. The processors 514 can include one or more central processing units (CPUs), graphic processing units (GPUs), field-programmable gate arrays (FPGAs), and/or application-specific integrated circuits (ASICs), such as tensor processing units (TPUs).

The instructions 518 can include one or more instructions that when executed by the processors 514, cause the one or more processors to perform actions defined by the instructions 518. The instructions 518 can be stored in object code format for direct processing by the processors 514, or in other formats including interpretable scripts or collections of independent source code modules that are interpreted on demand or compiled in advance. The instructions 518 can include instructions for implementing the multi-tenant compute cluster 502. The multi-tenant compute cluster 502 can be executed using the processors 514, and/or using other processors remotely located from the server computing device 504.

The data 520 can be retrieved, stored, or modified by the processors 514 in accordance with the instructions 518. The data 520 can be stored in computer registers, in a relational or non-relational database as a table having a plurality of different fields and records, or as JSON, YAML, proto, or XML documents. The data 520 can also be formatted in a computer-readable format such as, but not limited to, binary values, ASCII, or Unicode. Moreover, the data 520 can include information sufficient to identify relevant information, such as numbers, descriptive text, proprietary codes, pointers, references to data stored in other memories, including other network locations, or information that is used by a function to calculate relevant data.

The client computing device 506 can also be configured similarly to the server computing device 504, with one or more processors 522, memory 524, instructions 526, and data 528. The client computing device 506 can also include a client input 530 and a client output 532. The client input 530 can include any appropriate mechanism or technique for receiving input from a client, such as keyboard, mouse, mechanical actuators, soft actuators, touchscreens, microphones, and sensors.

The server computing device 504 can be configured to transmit data to the client computing device 506, and the client computing device 506 can be configured to display at least a portion of the received data on a display implemented as part of the client output 532. The client output 532 can also be used for displaying an interface between the client computing device 506 and the server computing device 504. The client output 532 can alternatively or additionally include one or more speakers, transducers or other audio outputs, a haptic interface or other tactile feedback that provides non-visual and non-audible information to a client of the client computing device 506.

Although FIG. 5 illustrates the processors 514, 522 and the memories 516, 524 as being within the computing devices 504, 506, components described herein, including the processors 514, 522 and the memories 516, 524 can include multiple processors and memories that can operate in different physical locations and not within the same computing device. For example, some of the instructions 518, 526 and the data 520, 528 can be stored on a removable SD card and other instructions within a read-only computer chip. Some or all of the instructions 518, 526 and data 520, 528 can be stored in a location physically remote from, yet still accessible by, the processors 514, 522. Similarly, the processors 514, 522 can include a collection of processors that can perform concurrent and/or sequential operations. The computing devices 504, 506 can each include one or more internal clocks providing timing information, which can be used for time measurement for operations and programs run by the computing devices 504, 506.

The computing devices 504, 506 can be capable of direct and indirect communication over the network 510. The devices 504, 506 can set up listening sockets that may accept an initiating connection for sending and receiving information. The network 510 itself can include various configurations and protocols including the Internet, World Wide Web, intranets, virtual private networks, wide area networks, local networks, and private networks using communication protocols proprietary to one or more companies. The network 510 can support a variety of short- and long-range connections. The short- and long-range connections may be made over different bandwidths, such as 2.402 GHz to 2.480 GHz, commonly associated with the Bluetooth® standard, 2.4 GHz and 5 GHZ, commonly associated with the Wi-Fi® communication protocol; or with a variety of communication standards, such as the LTE® standard for wireless broadband communication. The network 510, in addition or alternatively, can also support wired connections between the computing devices 504, 506, including over various types of Ethernet connection.

Although a single server computing device 504 and user computing device 506 are shown in FIG. 5, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

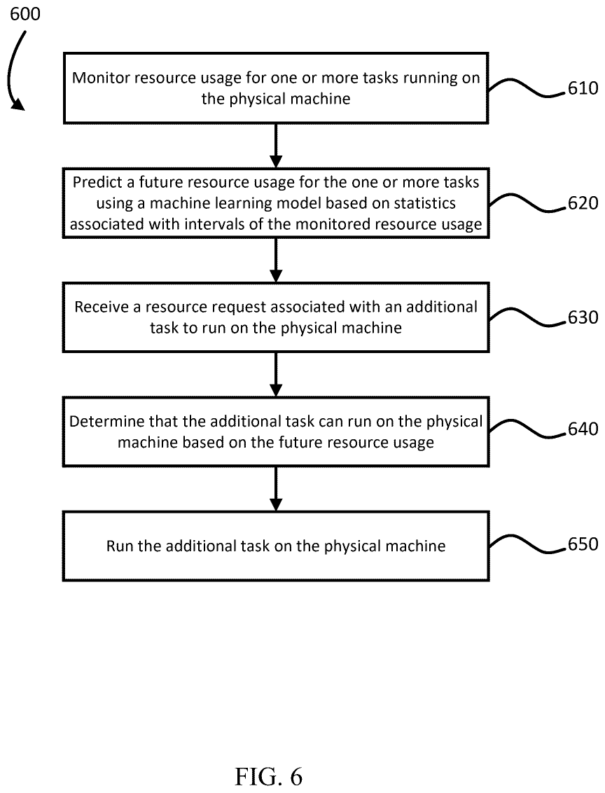

FIG. 6 depicts an example process 600 for overcommitting compute resources on a physical machine of a multi-tenant compute cluster. The example process 600 can be performed on a system of one or more processors in one or more locations, such as the multi-tenant compute cluster 100 as depicted in FIG. 1.

As shown in block 610, the multi-tenant compute cluster 100 monitors resource usage for one or more tasks running on the physical machine. The tasks can specify an amount of compute resources for running the respective tasks. Example compute resources can include number of processor cores, amount of memory, network bandwidth, and/or storage capacity. The multi-tenant compute cluster 100 can store the monitored resource usage as historical resource usage for the one or more tasks.

As shown in block 620, the multi-tenant compute cluster 100 predicts a future resource usage for the one or more tasks using a machine learning model based on statistics associated with intervals of the monitored resource usage. The future resource usage can be time series data. The intervals can include time and/or confidence intervals. The machine learning model can include a dense encoder and/or a Gaussian mixture model. The multi-tenant compute cluster 100 can predict the future resource usage by generating statistics associated with intervals of the monitored resource usage for each task, predicting per task future resource usages using the respective statistics, and combining the per task future resource usages based on the statistics. The per task future resource usages can be combined using the Bernstein inequality. The multi-tenant compute cluster 100 can train and/or evaluate the machine learning model using the historical resource usage for determining the future resource usage for the physical machine.

As shown in block 630, the multi-tenant compute cluster 100 receives a resource request associated with an additional task.

As shown in block 640, the multi-tenant compute cluster 100 determines that the additional task can run on the physical machine based on the future resource usage. The multi-tenant compute cluster can determine that the additional task can run on the physical machine based on determining that the future resource usage added to a resource usage of the resource request is less than or equal to a resource capacity of the physical machine.

As shown in block 650, the multi-tenant compute cluster 100 runs the additional task on the physical machine.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, which is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for overcommitting compute resources on a physical machine of a multi-tenant compute cluster, the method comprising:
monitoring, by one or more processors, resource usage for one or more tasks running on the physical machine;
predicting, by the one or more processors, a future resource usage for the one or more tasks using a machine learning model based on statistics associated with intervals of the monitored resource usage;
receiving, by one or more processors, a resource request associated with an additional task;
determining, by the one or more processors, that the additional task can run on the physical machine based on the future resource usage; and
running, by the one or more processors, the additional task on the physical machine.

2. The method of claim 1, wherein a task of the one or more tasks specifies an amount of compute resources for running that task.

3. The method of claim 1, wherein compute resources comprise at least one of number of processor cores, amount of memory, network bandwidth, or storage capacity.

4. The method of claim 1, wherein the future resource usage is predicted as time series data.

5. The method of claim 1, wherein the intervals comprise at least one of a time or confidence interval.

6. The method of claim 1, wherein the machine learning model comprises at least one of a dense encoder or a Gaussian mixture model.

7. The method of claim 1, wherein predicting the future resource usage further comprises:
generating, for each task, the statistics associated with intervals of the monitored resource usage;
predicting, for each task, a per task future resource usage using the respective statistics; and
combining the per task future resource usages based on the statistics.

8. The method of claim 7, wherein the per task future resource usages are combined using a Bernstein inequality.

9. The method of claim 1, wherein determining that the additional task can run on the physical machine based on the future resource usage further comprises determining that the future resource usage added to a resource usage of the resource request is less than or equal to a resource capacity of the physical machine.

10. The method of claim 1, further comprising storing, by the one or more processors, the monitored resource usage as a historical resource usage for the one or more tasks.

11. The method of claim 10, further comprising training, by the one or more processors, the machine learning model using the historical resource usage for determining the future resource usage for the physical machine.

12. A system comprising:
one or more processors; and
one or more storage devices coupled to the one or more processors and storing instructions that, when executed by the one or more processors, cause the one or more processors to perform operations for overcommitting compute resources on a physical machine of a multi-tenant compute cluster, the operations comprising:
monitoring resource usage for one or more tasks running on the physical machine;
predicting a future resource usage for the one or more tasks using a machine learning model based on statistics associated with intervals of the monitored resource usage;
receiving a resource request associated with an additional task;
determining that the additional task can run on the physical machine based on the future resource usage; and
running the additional task on the physical machine.

13. The system of claim 12, wherein a task of the one or more tasks specifies an amount of compute resources for running that task.

14. The system of claim 12, wherein the future resource usage is predicted as time series data.

15. The system of claim 12, wherein the intervals comprise at least one of a time or confidence interval.

16. The system of claim 12, wherein predicting the future resource usage further comprises:
generating, for each task, the statistics associated with intervals of the monitored resource usage;
predicting, for each task, a per task future resource usage using the respective statistics; and
combining the per task future resource usages based on the statistics.

17. The system of claim 16, wherein the per task future resource usages are combined using a Bernstein inequality.

18. The system of claim 12, wherein determining that the additional task can run on the physical machine further comprises determining that the future resource usage added to a resource usage of the resource request is less than or equal to a resource capacity of the physical machine.

19. The system of claim 12, wherein the operations further comprise:
storing the monitored resource usage as a historical resource usage for the one or more tasks; and
training the machine learning model using the historical resource usage for determining the future resource usage for the physical machine.

20. A non-transitory computer readable medium for storing instructions that, when executed by one or more processors, cause the one or more processors to perform operations for overcommitting compute resources on a physical machine of a multi-tenant compute cluster, the operations comprising:
monitoring resource usage for one or more tasks running on the physical machine;
predicting a future resource usage for the one or more tasks using a machine learning model based on statistics associated with intervals of the monitored resource usage;
receiving a resource request associated with an additional task;
determining that the additional task can run on the physical machine based on the future resource usage; and
running the additional task on the physical machine.
